(19) United States
(12) Patent Application Publication
(10) Pub. No.: US 2023/0408673 A1
(43) Pub. Date: Dec. 21, 2023

(54) METHOD FOR DETERMINING A POSITION IN PROCESS AUTOMATION

(71) Applicant: VEGA Grieshaber KG, Wolfach (DE)

(72) Inventor: Roland WELLE, Hausach (DE)

(73) Assignee: VEGA Grieshaber KG, Wolfach (DE)

(21) Appl. No.: 18/250,437

(22) PCT Filed: Oct. 26, 2020
(86) PCT No.: PCT/EP2020/080080

§ 371 Date: Apr. 25, 2023

(51) Int. Cl. G01S 13/42; G01S 13/88

(52) U.S. Cl. CPC G01S 13/42; G01S 13/88

(57) ABSTRACT

A method for determining a position of an object by a sensor, including setting a local sensor coordinate system, setting a global target coordinate system, determining transformation parameters for transforming coordinates in the local sensor coordinate system to coordinates in the global target coordinate system, capturing the position of the object in local coordinates, transforming the position of the object to coordinates in the global target coordinate system.

### FIELD OF INVENTION

The invention relates to a method for determining a position of an object by a sensor, a computing unit, a sensor, a system comprising a computing unit and a sensor, and the use of the computing unit in a system of process automation, factory automation, or in a multi-sensor environment with a plurality of location-variable sensors.

### INVENTION BACKGROUND

Two-dimensional or three-dimensional measuring radar systems can be used to globalize monitoring of areas in safety or automation technology. In addition, line-scanning, two-dimensional radar systems are known for conveyor belts for detecting the quantities of bulk material transported on them. The aforementioned systems have in common that the position of objects in the monitoring area is determined with respect to their distance and with respect to their angular position relative to the sensor itself, which is also sufficient for a variety of problems. Furthermore, three-dimensional measuring systems are known, especially for level measurement technology. In these systems, radar signals are applied to a bulk material layer in a container or on an openly stored bulk material stockpile, and a topology of the surface of the bulk material is calculated from the reflection of the same at the medium, from which the volume of the bulk material and, if the density is known, also the mass of the bulk material can be determined with high accuracy by known conversions.

Sensors in process automation or factory automation, for example, determine distances and angular positions in relation to the respective position of the respective sensor. For example, a radar sensor determines the distance to the product as the distance between a reference point (zero point) in the sensor and the surface of the product. Sensors for process and factory automation determine, in addition to the distance values, also angular values between the sensor and a respective reflector. These angle values are also specified in relation to an existing plane or marking on the sensor itself (“sensor reference plane”). A disadvantage of the previous methods is that the position or location of the product or an object is not known to a service employee from the outside.

### SUMMARY OF THE INVENTION

It is an object of the invention to provide a method and a system which overcome this deficiency.

The object is solved by the subject-matter of the independent patent claims. Advantageous embodiments are the subject-matter of the dependent claims, the following description, and the figures.

The described embodiments similarly relate to the method for determining a position of an object by a sensor, the computing unit, the sensor, the system comprising a computing unit and a sensor, and the use of the computing unit in a process automation or factory automation system or in a multi-sensor environment with a plurality of location-variable sensors. Synergistic effects may result from various combinations of the embodiments, although they may not be described in detail.

Other variations of the disclosed embodiments may be understood and carried out by those skilled in the art in carrying out the claimed invention by studying the drawings, the disclosure, and the appended claims. In the claims, the word “comprising” does not exclude other elements or steps, and the indefinite article “a” or “an” does not exclude a plurality. A single processor or other unit may perform the functions of multiple items or steps recited in the claims. The mere fact that certain actions are recited in interdependent claims does not mean that a combination of those actions cannot be advantageously used.

According to a first aspect, a method for determining a position of an object by a sensor is provided. The method comprises the steps of: Setting, i.e., specifying, a local sensor coordinate system, setting, i.e., specifying, a global target coordinate system, determining transformation parameters for transforming coordinates in the local sensor coordinate system to coordinates in the global target coordinate system, detecting the position of the object in local coordinates, and transforming the position of the object to coordinates in the global target coordinate system.

Thus, a method is proposed in which, for example, a multi-dimensional measuring sensor such as a radar sensor detects the direction from and distance to an object and position is specified in a global coordinate system. Thus, a service worker does not need to have knowledge of the orientation of the sensor to know where the object is located.

The term “sensor” is known to the person skilled in the art, for example, in process automation. Depending on the type and design, such a sensor can have, for example, an antenna, a detector of a measured variable, electronics for amplifying, processing and possibly digitizing a detected signal, a power supply unit, an interface to the outside, and an energy storage unit. The listed components are to be understood as examples only. The sensor is usually built into a housing. Thus, further units can also be integrated into the sensor, such as further sensors. To distinguish from these further sensors, such as acceleration sensors, which are mentioned in this disclosure, those are referred to as “auxiliary sensors”.

An “object” is, for example, an unwanted accumulation of matter on the wall of a container or, for example, bulk material for which the distribution in a container is to be determined and observed. Since, from the point of view of, for example, a radar sensor, the radar waves are reflected from the object, the term “reflection point” is often used in the examples in this disclosure to refer to an object, or more specifically, the position of the object. Furthermore, object is also understood to mean, for example, bulk material that has a topology as a result of being placed in a container, which is detected by the sensor.

The term “position” generally refers to complete coordinates, while the term “attitude” generally describes a direction or orientation, which, depending on the context, can be an orientation of the object or an attitude in space with respect to the sensor orientation. For example, a position of an object can be determined in a spherical coordinate system by adding a distance to the position information with respect to that system.

The term “local” refers to the sensor. The term “global”, on the other hand, refers to a possibly large-scale but still limited area, such as typically an industrial facility. In some embodiments, a defining component of the global coordinate system is the direction of gravity. Therefore, if the origin of the coordinate system is not the intersection of different gravitational directions, such as a geocentric coordinate system, the geographic extent of the area should be limited to the extent that the gravitational direction can still be considered “equal” to accomplish the task of the invention. Otherwise, for example, a global geodetic coordinate system may be used as the global coordinate system.

The direction is initially related to a local sensor coordinate system, which will be described in more detail in the following embodiments. The local sensor coordinate system is not always known to a service technician, for example. If the position in the local coordinate system were communicated to the technician, for example, it would also have to be ensured that this does not change until the technician arrives, for example by moving it. Especially in a plant with a large number of sensors, the technician would still have to reorient himself for each sensor. By remote transmission of the coordinates of an object in the global target coordinate system, the position of the object can be transmitted to the technician already in a remote service center or at a remote location, for example in a graphical representation, e.g. on a smartphone, computing device or a paper printout, and can also be displayed on site. This makes the service much simpler, faster and less error-prone, and thus more economical. The evaluation of the transmitted coordinates in a uniform system is uncomplicated.

The target coordinate system is not necessarily the final coordinate system. Rather, the object coordinates can still be transformed into one or more further coordinate systems.

According to an embodiment, the local coordinate system is a spherical coordinate system or a Cartesian coordinate system, and the step of setting a local coordinate system includes defining a sensor plane as an equatorial plane or xy-plane, a center of the sensor plane as an origin of the coordinate system, and a reference point on the outside of the sensor plane as a reference direction or direction of one of the axes in the sensor plane from the origin toward the reference point.

The local sensor coordinate system is thus, for example, a spherical coordinate system whose polar axis is the main direction, e.g. the central radiation and reception direction of the antenna of the radar sensor. The polar axis is, for example, perpendicular to the lower side or surface of the sensor. The lower side or surface is thereby, for example, parallel to the surface of a container on which the sensor is mounted. This surface, also referred to as the sensor plane in this disclosure, may serve as the equatorial plane. The origin or center of the coordinate system is, for example, the center of the sensor plane limited to the extent of the sensor. A reference direction for the azimuth may be, for example, by a marker or by the exit point of a cable at or into the sensor plane. In the case of a Cartesian sensor coordinate system, if the origin is the same, the azimuth reference direction would correspond to the x-axis, for example, and the pole direction would correspond to the z-axis, and the y-direction is derived accordingly. The basic sensor coordinate system is advantageously chosen according to the characteristics of the sensor. For example, if the sensor is a radar sensor that measures distances and directions, a spherical coordinate system is preferably used. Since from the point of view of a person skilled in the art the transformation from the local spherical coordinate system into the corresponding Cartesian system is trivial, and a distinction is not necessary for the further procedure, in the following the special naming of both coordinate systems is largely omitted. With data such as elevation, azimuth and distance the skilled person reads in case of these corresponding local coordinate systems thus the Cartesian equivalents as for example gradient in x and y direction and/or xyz coordinates.

According to an embodiment, the step of detecting the position of the object in local coordinates includes determining an elevation and an azimuth with respect to a reference direction of the local sensor coordinate system. The elevation indicates the inclination with respect to the equatorial plane of the sensor spherical coordinate system, while the azimuth is the rotation with respect to the reference direction. Distance is also necessary to determine position. The distance is measured by the sensor itself, and is therefore readily determinable. If the local sensor coordinate system and the global target coordinate system have the same origin, the distance remains the same, so there is no need for translation. For the transformation into the target coordinate system, the spherical coordinates are conveniently first converted into Cartesian coordinates of a local Cartesian coordinate system.

According to a further embodiment, the global target coordinate system is a Cartesian coordinate system having an orientation of one of its axes in a celestial direction and an orientation of one of its other axes in a gravitational direction, or a geodetic coordinate system. For example, a preferred cardinal direction is south or north. The choice of the direction of gravity as one of the axes allows the use of sensors whose measurement principle is based on gravity as well as other methods described below. A geodetic coordinate system, such as WGS84, has the advantage that it is not locally restricted and that some satellite navigation systems use this system. However, the conversion is comparatively complex.

According to a further embodiment, the plane determined by the direction of gravity as a normal lies at a container-related height. In other words, the gravitational direction as normal vector defines a set of planes. From this, a plane is selected which lies at an expediently selected height of the container, for example at or near the bottom of the container.

According to a further embodiment, a transformation parameter is an inclination about a first axis of the local coordinate system, an inclination about a second axis of the local coordinate system, and/or a torsion angle indicating the torsion in the sensor plane with respect to a reference direction, and the inclination about the first axis, and/or the inclination about a second axis is obtained by one or more of the following methods: A first method includes sensing the tilt about the first and/or second axis by a protractor or by a sensor measuring the tilt about the first and/or second axis from an additional external device, such as a smartphone. A second method includes sensing the tilt about the first and/or second axis by a tilt and/or acceleration sensor in the sensor. A third method includes sensing a falling direction of bulk material during a filling operation as a gravitational direction by the sensor and determining the tilt about the first and/or second axis based on the gravitational direction. A fourth method includes sensing a direction of planar surfaces of a container wall as a gravitational direction and determining the inclination about the first and/or second axis based on the gravitational direction. Here, a planar surface means, for example, a perpendicular wall of a container that is rectangular, for example, or cylindrical, for example. If the local coordinate system is a spherical coordinate system, the transformation can, as already described, transform in an intermediate step to a local Cartesian coordinate system and from there to the Cartesian target coordinate system. However, the terms inclination about the first or second axis mentioned in this embodiment are not to be confused with the elevation or azimuth of the object with respect to the local sensor spherical coordinate system. The tilt about the first and/or second axis of this embodiment relates to the relationship between the local sensor system and the global coordinate system to determine the value of the two tilt transformation parameters, for example, the tilt of the polar direction with respect to the gravitational direction. A reference direction for the tilt angle can again be, for example, by a marker or by the exit point of a cable at or into the sensor plane. So here the position of the sensor or the local coordinate system is related to the global coordinate system. The position of the sensor can be determined by additional sensors in the sensor, which can detect the inclination to the gravitational direction, or by additional sensors located in an additional external device, for example a smartphone, if the additional external device is inclined according to the orientation or pole direction of the sensor or local sensor spherical coordinate system. The inclination about the first and/or second axis can also be determined optically, for example by means of the falling direction of a medium such as the bulk material.

According to an embodiment, another transformation parameter is a tilt angle, and at least one of the transformation parameters tilt about the first axis, tilt about the second axis, and tilt angle, respectively, is obtained by one or more of the following methods: In a first method, an image of the sensor and a marker of the sensor are captured by a smartphone and a smartphone camera, respectively, and the reference direction of the local coordinate system is determined based thereon, and a cardinal direction is determined by measuring the earth's magnetic field with a smartphone compass, and finally, the torsion angle is determined based on the cardinal direction and the reference direction. In a second method, the smartphone includes an auxiliary sensor capable of measuring a tilt with respect to a gravitational direction and an auxiliary sensor capable of measuring a twist angle. For example, this auxiliary sensor, such as a gyroscope, can sense how many degrees a smartphone is rotated to move from the marking direction to a southward orientation. The smartphone does not have to be actively rotated in this case, but can contain functions that, for example, automatically determine the deposit to the south pole direction relative to the current orientation. Another method is to detect the container shape by scanning the container and determining the inclination about the first axis or the second axis using a plant plan that shows the container orientation and the container shape. The external, i.e. global, reference is thus obtained here by a plant plan. The plant plan can be stored, for example, in a database or a memory, so that access and use can be automated.

In other words, according to this embodiment, either the torsion angle alone or both the torsion angle and the inclination about the first and/or second axis are determined. For the torsion angle, an e.g. magnetic orientation by e.g. a compass needle, can be compared or measured optically with the line from the origin to a marker or a prominent point, i.e. the reference direction.

According to an embodiment, an auxiliary sensor in the sensor is one or more of the following: a compass, a satellite navigation receiver, an acceleration sensor, a celestial observation unit comprising at least an optical, a date and a time detection unit. A global orientation can also be determined by an antenna array of a GPS receiver or by an accelerometer. Another possible method is based on celestial observation units. For example, a position of the sun can be determined. E.g. the position of the sun at sunset at a certain day and time can be calculated, from which a simple difference to the reference direction of the local spherical coordinate system gives the angle of rotation.

According to an embodiment, the coordinates in the target coordinate system are further transformed to a user-defined coordinate system by user-defined translation parameters. For example, the axes have the same orientation, but the origin is set to a point such as the center of the bottom plane of a container. The user-defined coordinate system can thus be another sensor-specific coordinate system with the orientation of a global coordinate system. A service employee can thus use a container information or sensor ID to immediately identify the container via this, as well as to recognize the position of the object. In this case, he does not have to determine the container or the sensor via global coordinates, e.g. on the basis of a plan.

According to an embodiment, the origin of the user-defined coordinate system is at a bottom, e.g., at the center of the bottom plane, of a container. However, the origin may also be defined at a corner point or a point on the top. Another suitable point would be the origin of the local coordinate system. This would then correspond to a translation of 0 if the origin of the target coordinate system has not been set at another point in space. In this case, the target coordinate system and the user-defined coordinate system are identical.

According to an embodiment, the method further comprises the step of transmitting the coordinates of the object in the target coordinate system or in the user-defined coordinate system to a data acquisition unit via an interface.

The coordinates can be stored locally and transferred to a smartphone, tablet, or service device on site via NFC (Near Field Communication), for example. However, they can also be transferred to a server, an evaluation unit, or to a cloud via a wired or wireless connection using a fieldbus, an Ethernet/Internet connection, or a cellular connection.

Furthermore, measured, determined and/or configured values, parameters and data such as transformation parameters, image data, GPS data, radar sensor measurement data, geometric data of the plant, the containers, etc. can be sent to a server, an evaluation unit or to the cloud so that the steps can be carried out partially or completely in the sensor, in the server, in an evaluation unit and/or a service in the cloud. Corresponding wireless or wired transmission paths, in particular of process automation, as well as the corresponding interfaces are known to the person skilled in the art and are not explained further here.

According to a further aspect, a computing unit is provided comprising a program element that instructs the computing unit to perform the steps of the method. For example, the computing unit may be arranged in a server, in an evaluation unit, and/or as a service in the cloud. That is, the computing unit may also be a logical unit that is physically distributed across multiple units, e.g., different hardware units.

According to a further aspect, there is provided a sensor comprising such a computing unit. The sensor is, for example, a radar sensor, a laser sensor, an ultrasonic sensor, or a comparable sensor that can be used to measure distances and directions. “Sensor” may also be understood herein as an ensemble of sensors that interact with each other as one such sensor. In this case, for example, one of the ensemble sensors may serve as the sensor to which the local coordinate system is referenced.

According to a further aspect, a system is provided comprising a computing unit and a sensor for determining a position of an object in a local coordinate system. The sensor may be an ensemble of sensors as described. The computing unit may be a computing unit as described that transforms the determined position or coordinates in the local coordinate system into coordinates of a global or user-defined coordinate system.

Thus, a multi-dimensional measuring radar system is proposed, which provides at least two spatial coordinates characterizing a reflection point. The spatial coordinates are in fixed dependence to globally and/or user-specified fixed points.

According to a further aspect there is provided a use of the computing unit in a process automation system, factory automation system, or in a multi-sensor environment having a plurality of location-variable sensors.

Thus, by using the described system or method, it is possible for a multi-dimensional measuring radar system to provide the location of a plurality of reflection points to the outside world. Thus, a data set describing a plurality of reflection points can be efficiently transmitted and applied by wire or wirelessly to a remote facility, such as a control room or cloud. In order that this transmitted data of a plurality of measuring points can be displayed, evaluated and correctly interpreted in a uniform form, it is intended to relate the position of the transmitted reflection points to a globally determinable reference position that is independent of the mounting position of the sensors, and/or to refer to it.

### BRIEF DESCRIPTION OF THE FIGURES

In the following, embodiments of the invention are described in detail with reference to the accompanying figures. Neither the description nor the figures are to be construed as limiting the invention. Here shows

FIG. 1 a sketch of a system with a container and a one-dimensional measuring sensor in a 2D coordinate system,

FIG. 2 a sketch of a system with a container and a multi-dimensional measuring sensor in 3D coordinate systems according to an embodiment,

FIG. 3 Sketch of a system with several containers and sensors in 3D coordinate systems according to an embodiment,

FIG. 4 a flow chart of a process according to an embodiment,

FIG. 5 a block diagram of a system according to an embodiment.

The drawings are merely schematic and not to scale. In principle, identical or similar parts are given the same reference signs.

### DETAILED DESCRIPTION OF THE FIGURES

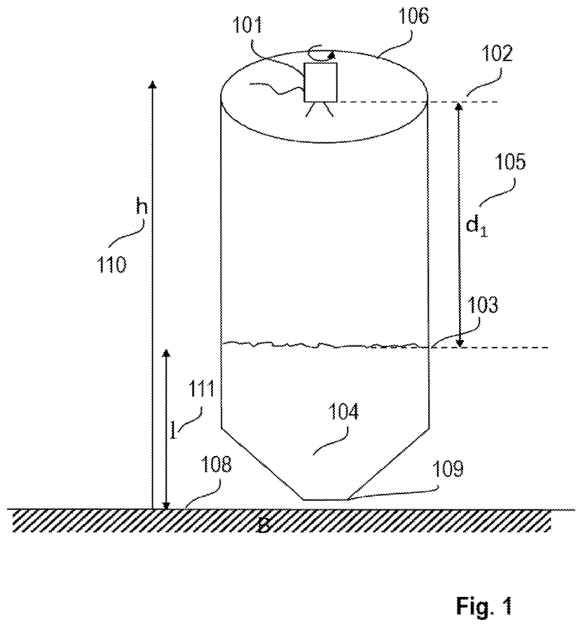

FIG. 1 first shows a one-dimensional measuring radar sensor 101. In particular, the sensor 101 determines the distance d1 105 between its sensor reference surface 102 or its internal zero point 102 and the surface 103 of the medium 104 to be measured according to a time-of-flight method. In the arrangement shown, the determined measured value d1 105 is independent of a possibly rotated mounting 106 of the sensor. In other words, it can also be determined that the measurement is independent of the mounting rotation angle 106 of the sensor. However, a user has the ability to adjust the sensor reference point 102 to suit the application by specifying constant correction terms. In particular, the user has the possibility to set the measured values output by the measuring device 101 in relation to a freely selected reference point 108, which often corresponds to the height position of the container bottom 109. By additionally specifying the container height h 110, the sensor 101 can continuously provide the level l 111 or, in other words, the height position of the surface 103 of the medium 104 in relation to the reference height B 108 as a derived value as a measured value.

Tilting of the sensor 101, and here in particular tilting of the sensor reference plane 102, can be automatically determined by a position sensor integrated in the sensor, and using trigonometric functions the orthogonal distance between the surface 103 and the sensor 101 can be automatically determined from the determined oblique distance. A twisting 106 of the sensor 101 along its axial direction remains without effect on the measured value even in the case of oblique mounting and is consequently not evaluated.

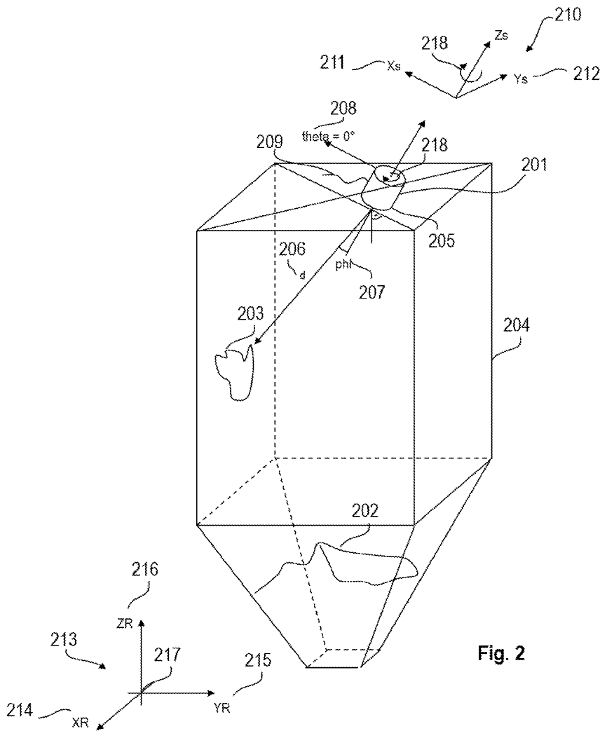

FIG. 2 shows an example of a multi-dimensional measuring device or sensor 201, in this case a three-dimensional measuring radar sensor 201 for detecting the topology of a bulk material surface 202. In one example, the sensor is further configured to provide the position of individual reflection points 203 in the container 204 to the outside. Referring to the embodiments of FIG. 1, the multi-dimensional measuring radar sensor 201 has a sensor reference surface 205 or an internal zero point 205 from which the distance values d 206 to various reflectors 202, 203 in the detection area of the sensor 201 are determined. The position of a reflection point 202, 203 is further characterized in a two-dimensional measuring radar sensor by the first angular distance phi 207 with respect to the surface normal of a plane E, which is defined by the sensor reference surface 205, for example a mounting flange. Without limiting generality, it may be assumed here that the 0° direction of the first angular position 207 is defined perpendicular to the reference surface 205. However, other directions of origin may also be selected.

Furthermore, in the present example of a three-dimensional measuring radar sensor, the second angular deposit theta perpendicular to the first deposit angle phi 207 is usually determined parallel to the plane E 205 inclined by phi, and in conjunction with the other coordinates characterizes the position of a reflector 202, 203 by specifying the spherical coordinates which originate at the center of the sensor reference plane 205. The definition of the second deposition angle theta 208 requires a definition of a 0° direction within the sensor 201, and at this point, for example, the direction 208 at which the connection cable 209 leaves the sensor housing may be used. However, another determination of the direction for theta=0° can also be made and made visible to the outside, for example, by a graphic marking on the sensor housing.

The determined pole or spherical coordinates are converted into Cartesian sensor coordinates 210 in a usual processing step, whereby the position of individual reflectors 202, 203 is unambiguously defined with respect to the sensor 201. Particularly advantageously, but by no means restrictively, it may be assumed below that the conversion is performed such that the plane spanned by the coordinate axes Xs 211 and Ys 212 is parallel to or identical to the sensor reference surface 205, and the Xs axis extends in the direction theta=0°.

In a next, constructive process step, it may be provided to convert the position of individual reflectors 203 with respect to a coordinate system 213 that can be predetermined by the respective user. The coordinate system 213 can be largely freely selected by the user. In a large number of applications, the orientation of the axes XR, YR, ZR, 214, 215, 216 corresponds to the directions of our usual, global sensory perception, i.e., the plane spanned by the axes XR 214 and YR 215 corresponds to a horizontal plane, and the ZR axis 216 runs as a surface normal of the horizontal plane along the direction of gravity. The origin 217 of the coordinate system is often a point defined in the vicinity of the container 204 or in the center of the container 204, the elevation of which corresponds to the elevation of the product surface of an almost completely emptied container (cf. also the analogy to FIG. 1).

If the coordinate system 213, referred to here as the “global coordinate system”, which may also have its origin at the elevation and center of the reference plane 205 of the sensor 201 when the sensor 218 is delivered, for example, is selected for outputting the positions of individual reflectors 203, a conversion of the coordinates of this point from the coordinate system 210 of the sensor 201 can be performed in a largely automated manner if the sensor 201 has available its inclination angles in both directions resulting from the mounting position. In one embodiment, it may be provided to measure the inclination of the reference plane 205, for example with respect to a horizontal plane or with respect to the perpendicular, with a measuring device, for example a protractor or a smartphone, after mounting has been performed, and to make it known to the sensor 201 via an interface. Alternatively, it may also be provided to automatically detect at least one of the inclination angles of the reference plane 205 (which corresponds to the plane Xs 211, Ys 212) with respect to a horizontal plane or with respect to the perpendicular via inclination or acceleration sensors integrated in the sensor 201. It may also be provided to detect the perpendicular during operation of the sensor 201 from the direction of fall of bulk material during a filling process, or to interpret a direction of planar surfaces, as often defined by container walls, as perpendicular.

However, the foregoing embodiments and disclosures are not sufficient to provide a reliable conversion of the sensor coordinates 210 of a reflector 203 into global coordinates 213 that can be easily interpreted. With the aid of the inclination angles of the reference plane 205 provided in the sensor 201 according to one of the above embodiments, the sensor coordinate system 210 and all coordinates of individual reflectors determined thereabove can be “straightened”, i.e., it can be achieved that the plane spanned by the converted coordinate axes Xs' and Ys' is parallel to the plane XR 214 and YR 215 of the global coordinate system 213 to be ultimately achieved. Since the sole inclusion of the inclination angles of the reference plane 205 does not allow for a rotation 218 of the sensor 201 with respect to the container 204 and thereby also with respect to a global coordinate system 213, a significant deficiency would arise here. Therefore, it may be provided here in particular to make known and thus evaluable not only the inclination of the reference plane 205 but also a torsion 218 of the sensor 201 with respect to a globally determinable fixed point in the sensor 201 itself located outside the sensor 201. Thus, in one embodiment, a determination of the torsion 218 in relation to a fixed coordinate system can be impressed by user input during a commissioning of the sensor 201. However, a disadvantage of this solution is that during a transport of the container 204 this twist may be changed between individual measuring cycles, in particular in relation to a fixed reference direction outside the container 204. Therefore, it may also be provided to detect the twist 218 by external measuring devices, and to transmit it to the sensor 201 via known communication channels. In particular, it may be provided to photograph the sensor 218 with a smartphone, and with the aid of, for example, a compass integrated in the smartphone and appropriately executed image processing to locate a marker or a cable outlet 209, determine the deviation of the 0° direction 208 of the sensor 201 from a globally available reference location, for example the south pole. It may also be envisaged to align the smartphone via a corresponding marker attached to the sensor 201 in such a way that the smartphone can determine both the inclination of the plane 205 and the torsion 218 and transmit these to the sensor 201. In a particularly advantageous embodiment, it may also be provided, in particular, that the tilt 218 and/or inclination of the sensor 201 with respect to a globally available fixed point is determined automatically by fixed point determination devices integrated in the sensor 201, such as compass, GPS, acceleration sensors, celestial observation units such as a camera with time and date, e.g., for detecting the sunrise and sunset. e.g., to detect sunrise, or by a bin scan to detect the bin shape with the addition of a facility plan indicating the bin orientation and shape, and to use it to transform the coordinates of specific reflection points 202, 203 from the sensor coordinate system 210 to a global coordinate system 213.

For example, the global coordinate system 214 used by the user may always be oriented so that the XR axis 214 is oriented toward the south. However, other orientations more suitable for the particular application may be selected. It should be noted at this point, however, that the selection of a different orientation represents a static transformation from the global coordinate system 213 to another user coordinate system Bx, which can be performed by a one-time specification of fixed offsets in translation and/or rotation direction according to known procedures.

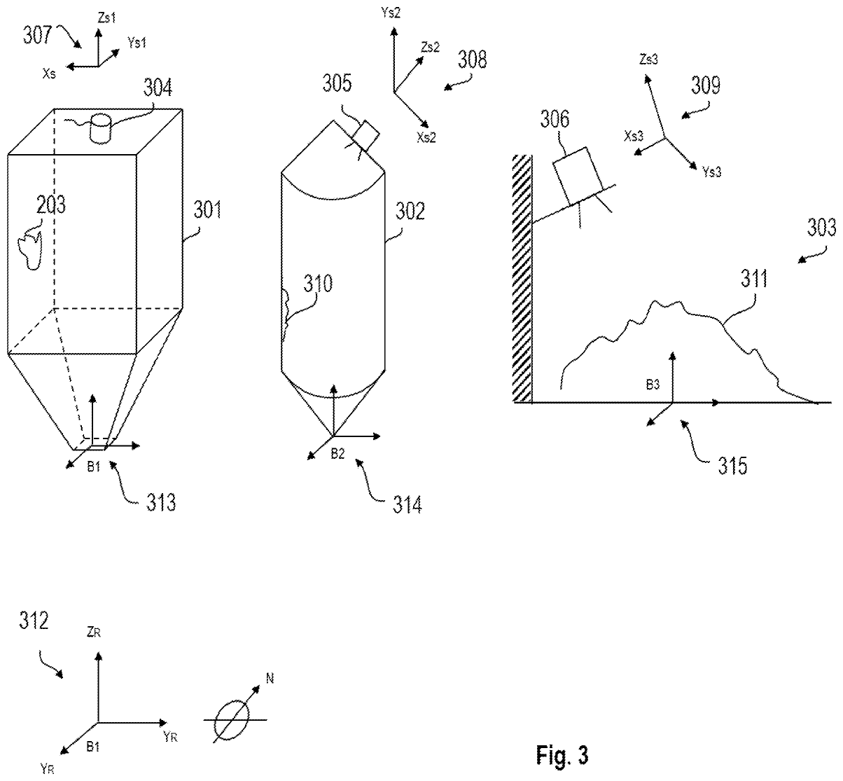

FIG. 3 again illustrates the particular advantage of the invention when operating a plurality of sensors in a plant. The bins 301, 302 belonging to the plant as well as the open bulk stockpile 303 are equipped with multi-dimensional measuring radar sensors 304, 305, 306. The sensors 304, 305, 306 differ significantly from each other both with respect to their respective inclination of the sensor reference plane (e.g., the mounting flange) relative to a reference plane, for example a horizontal plane, and with respect to the respective torsion 218 on the respective measuring point 301, 302, 303. Accordingly, the sensor-specific coordinate systems 307, 308, 309 are also significantly different from each other. Without the application of the basic ideas of the present invention, each of these sensors would be able to determine the position of individual reflectors 203, 310 or the position of the topology of a bulk material surface 311 only with respect to its own sensor electronics or its local sensor coordinate system. If these values are transmitted to a central evaluation and visualization device, no statement can be made as to which container wall, for example within the containers 301, 302, a caking 203, 309 has occurred on without precise knowledge of the respective mounting situation of the sensor, i.e. angle of inclination of the reference plane with respect to a reference plane, angle of twist and, if necessary, mounting height. An essential effect is therefore that a uniform processing of the coordinates is achieved independently of the respective mounting position of the sensor 201. For this purpose, in an exemplary embodiment, the coordinates of at least one reflection point determined in relation to the sensor coordinate systems 307, 308, 309 are converted in relation to a sensor-independent global coordinate system 312, 213, taking into account predeterminable and/or independently determined information on the mounting situation, i.e., angle of inclination of the reference plane with respect to a reference plane, angle of torsion and, if applicable, mounting height. For example, it can be provided to align or define the axis XR of the coordinate system 312 in the south direction, and the axis ZR along the plumb direction, whereby these two directions can be determined at any point in the world independently of a mounting situation of a sensor.

It may also be provided to define the zero point, i.e. the origin of the coordinate system 312, globally unambiguously. For example, it is provided to define the origin of the coordinate system 312 directly in the center of one of the reference planes of the respective sensor 304, 305, 306, similar to the known approach of the sensor 106 according to FIG. 1. However, it may also be provided to use a uniform altitude reference independent of the respective application, such as the sea level. The determination of an absolute elevation of the sensor with respect to a uniform, globally available elevation may be globalized by user input or automated by sensors integrated in the sensor, referred to in this disclosure as auxiliary sensors, and/or auxiliary sensors externally in communication with the sensor.

The most important element of the conversion of sensor coordinates 218, 307, 308, 309 to global coordinates 213, 312 is that twists and/or tilts of the sensors 304, 305, 306 can be eliminated by this first conversion, so that values supplied by the sensors with respect to the orientation of the coordinate axes XR, YR, ZR are unambiguous and independent of the respective mounting situation.

In an optional further or combined method step, similar to the procedure of FIG. 1, a user can change the origin of the global coordinate system 312 used by the sensor to output values for each sensor according to his needs, for example by entering the container height and/or presetting offsets for the X and Y axes. In this way, a user-defined coordinate system B1, 313, B2, 314, B3, 315 is created for each of the containers 301, 302, 303, which in a large number of cases is defined in such a way that the origin of the respective system is located in the center of the bottom of the respective container, and at the same time the X axis is oriented, for example, in the direction of the south and the Z axis is oriented along the perpendicular. If a caking at a point P with defined Xp, Yp and Zp coordinates is now output by the respective sensor as a measured value in relation to the coordinate system specified by the user, a service employee on site at the container can very easily and unambiguously record the position of the respective reflection point with the aid of a compass or a smartphone. The parallel display and joint evaluation of a large number of bulk material topologies in a plant with a large number of different containers and orientations can now also be carried out simply and uniformly, especially if the orientation of existing containers in relation to the cardinal direction is apparent from plant plans.

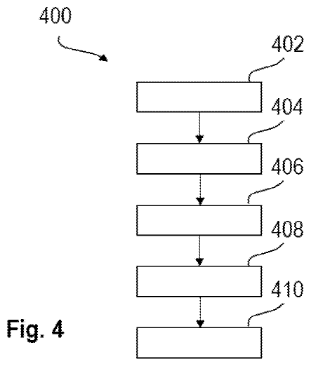

FIG. 4 illustrates a method 400 for determining a position of an object by a sensor. In a first step 402, a local sensor coordinate system is determined. In a second step 404, which may also occur before or simultaneously with step 402, a global target coordinate system is determined. In a further step 406, transformation parameters for transforming coordinates in the local sensor coordinate system to coordinates in the global target coordinate system are determined. In the next step 408, the position of the object in local coordinates is acquired, and in step 410, the position of the object is transformed to coordinates in the global target coordinate system.

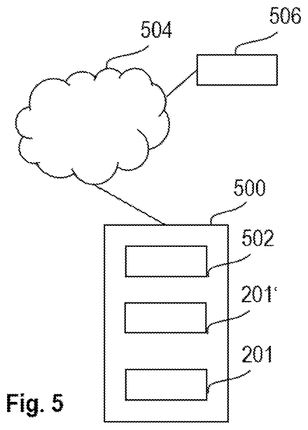

FIG. 5 shows a block diagram of a system 500 comprising a sensor 201 described herein and a computing unit 502 described herein in which the transformation is performed. The system 500, or computing unit 502, for example, includes an interface to a cloud 504. The cloud 504 may comprise, for example, a server and/or a storage unit on which the coordinates are cached. A data acquisition unit 506 can retrieve the data or coordinates in this example from the server, further process them, e.g., graphically, and provide them in a suitable form to a service employee. The coordinates of the object 203, 310, 311 are thereby also transmitted, for example, for further sensors 201′ in the system 500 in the same target coordinate system 217, 312, or for each sensor 201, 201′ in the user-defined coordinate system (313, 314, 315).

The embodiments shown above relate to applications in the field of process automation. However, the principles and embodiments of the present invention can also be applied in a manner obvious to those skilled in the art to sensors in the field of factory automation or safety technology for general monitoring of areas with a large number of sensors and a large number of mounting situations. Here, too, it can be of particular advantage to provide the position of individual reflectors not in relation to the mounting situation of the sensor, but (at least partially) in relation to a globally determinable fixed point.

It should also be considered in the context of the present invention that the conversion of the coordinates determined by the sensor into global coordinates can take place in the sensor itself, but also in an evaluation unit or a cloud. It may be provided that, in addition to the measurement data, the sensor also outputs information with respect to its mounting situation, e.g. angle of inclination of the reference plane, angle of twist and, if applicable, mounting height. It is also possible for evaluation units or cloud systems to obtain this information from a database or from a mounting situation detection unit, for example an on-site camera.

The embodiments shown above predominantly use Cartesian coordinate systems. In the context of the invention, it would also be possible, in a manner obvious to the person skilled in the art, to use other coordinate systems such as polar coordinate systems or spherical coordinate systems to implement the invention. In particular, systems with geographic longitude and latitude can also be used.

1. A method for determining a position of an object by a sensor, comprising:
setting a local sensor coordinate system;
setting a global target coordinate system;
determining transformation parameters to transform coordinates in the local sensor coordinate system to coordinates in the global target coordinate system;
capturing the position of the object in local coordinates; and
transforming the position of the object to coordinates in the global target coordinate system.

2. The method according to claim 1, wherein the local coordinate system is a spherical coordinate system or a Cartesian coordinate system, and wherein setting a local coordinate system comprises defining a sensor plane as an equatorial plane or xy plane, a center of the sensor plane as an origin of the local coordinate system, and a reference point on the outside of the sensor plane as a reference direction or direction of one of the axes in the sensor plane from the origin toward the reference point.

3. The method of claim 1, wherein capturing the position of the object in local sensor coordinates includes determining an elevation and an azimuth with respect to a reference direction of the local sensor coordinate system.

4. The method according to claim 1, wherein the global target coordinate system is a Cartesian coordinate system having an orientation of one of its axes in a celestial direction and an orientation of one of its further axes in a gravitational direction, or is a geodetic coordinate system.

5. The method according to claim 1, wherein a plane determined by a direction of gravity, as a normal lies, at a container-related height.

6. The method according to claim 1, wherein a transformation parameter is an inclination about a first axis of the local coordinate system, an inclination about a second axis of the local coordinate system, and/or a torsion angle indicating torsion in a sensor plane with respect to a reference direction, and the inclination about the first axis and/or the inclination about the second axis is obtained by one or more of following methods:
detection of the inclination about the first and/or second axis by a protractor or by an additional sensor of a smartphone measuring the inclination about the first and/or second axis;
detection of the inclination about the first and/or second axis by an inclination and/or acceleration sensor in the sensor;
detection of a direction of fall of bulk material during a filling process as a direction of gravity by an additional sensor and determination of the inclination about the first and/or second axis based on the direction of gravity; and
detection of a direction of a surface of a container wall as a direction of gravity and determining tilt about the first and/or second axis based on the direction of gravity.

7. The method according to claim 1, wherein a further transformation parameter is a twist angle, and wherein at least one of the transformation parameters tilt about a first axis, a second axis, and/or twist angle is obtained by one or more of the following methods:
capturing an image of the sensor and a mark of the sensor with a smartphone and determining a reference direction based thereon, determining a cardinal direction by measuring the earth's magnetic field with a smartphone compass, and determining a torsion angle based on the cardinal direction and the reference direction;
alignment of the smartphone via a corresponding marker attached to the sensor and detection of tilt about the first axis, the second axis, and/or the tilt angle by additional sensors of the smartphone; and
detecting a container shape by scanning a container and determining the tilt about the first and/or second axis using a layout plan that shows the container orientation and container shape.

8. The method according to claim 7, wherein the additional sensors in the sensor is one or more of a compass, a GPS receiver, an accelerometer, a celestial observation unit comprising at least an optical, a date and a time detector.

9. The method according to claim 1, wherein the coordinates in the target coordinate system are further transformed to a user-defined coordinate system by user-defined translation parameters.

10. The method of claim 9, wherein an origin of the user-defined coordinate system is at a bottom of a container.

11. The method according to claim 1, wherein the method further comprises
transmitting the coordinates of the object in the target coordinate system or in a user-defined coordinate system via an interface to data acquisition unit.

12. A device comprising:
memory storing a program element for determining a position of an object by a sensor;
a processor configured to execute the program element by being configured to:
set a local sensor coordinate system;
set a global target coordinate system;
determine transformation parameters to transform coordinates in the local sensor coordinate system to coordinates in the global target coordinate system;
capture the position of the object in local coordinates; and
transform the position of the object to coordinates in the global target coordinate system.

13. A sensor comprising the device according to claim 12.

14. A system comprising:
the device according to claim 12 and a sensor for determining a position of an object in a local coordinate system.

15. (canceled)

16. A non-transitory computer readable medium having stored thereon a program that when executed by a computer causes the computer to implement a method for determining a position of an object by a sensor, comprising:
setting a local sensor coordinate system;
setting a global target coordinate system;
determining transformation parameters to transform coordinates in the local sensor coordinate system to coordinates in the global target coordinate system;
capturing the position of the object in local coordinates; and
transforming the position of the object to coordinates in the global target coordinate system.

17. The method of claim 2, wherein the capturing the position of the object in local sensor coordinates includes determining an elevation and an azimuth with respect to a reference direction of the local sensor coordinate system.

18. The method according to claim 2, wherein the global target coordinate system is a Cartesian coordinate system having an orientation of one of its axes in a celestial direction and an orientation of one of its further axes in a gravitational direction, or is a geodetic coordinate system.

19. The method according to claim 3, wherein the global target coordinate system is a Cartesian coordinate system having an orientation of one of its axes in a celestial direction and an orientation of one of its further axes in a gravitational direction, or is a geodetic coordinate system.

20. The method according to claim 2, wherein a plane determined by a direction of gravity, as a normal lies, at a container-related height.

21. The method according to claim 3, wherein a plane determined by a direction of gravity, as a normal lies, at a container-related height.
